(19) United States
(12) Patent Application Publication
(10) Pub. No.: US 2022/0019190 A1
(43) Pub. Date: Jan. 20, 2022

(54) MACHINE LEARNING-BASED METHODS AND SYSTEMS FOR DEFFECT DETECTION AND ANALYSIS USING ULTRASOUND SCANS

(71) Applicant: Saudi Arabian Oil Company, Dhahran (SA)

(72) Inventors: Kaamil Ur Rahman Mohamed Shibly, Al-Khobar (SA); Ahmad Aldabbagh, Dhahran (SA)

(21) Appl. No.: 16/928,234

(22) Filed: Jul. 14, 2020

(51) Int. Cl. G05B 19/406; G06N 20/00; G06N 5/04; G06T 7/00; G06K 9/46; G06K 9/62

(52) U.S. Cl. CPC G05B 19/406; G06N 20/00; G06N 5/04; G06Q 10/20; G06K 9/46; G06K 9/6267; G06K 9/6256; G06T 7/0004

(57) ABSTRACT

A technological solution for analyzing a sequence of ultrasound scan images of an asset and diagnosing a health condition of a section of the asset. The solution includes receiving, by a machine learning platform, an ultrasound scan image of the section of the asset; analyzing, by the machine learning platform, the ultrasound scan image to detect any aberrations in the section; generating, by the machine learning platform, an aberration label for each detected aberration in the section; labeling, by the machine learning platform, the section of the asset with a section condition label; and, rendering, by a display device, the section conditional label. The section condition label can be based on each detected aberration in the section. The section condition label can include at least one of an aberration area ratio, a total number of aberrations, and the aberration label for each detected aberration in the section of the asset.

### FIELD OF THE DISCLOSURE

The present disclosure relates to a method, a system, an apparatus and a computer program for inspecting, detecting, monitoring, analyzing or assessing assets using ultrasound imaging, including detecting, identifying, monitoring, analyzing or assessing aberrations in the assets.

### BACKGROUND OF THE DISCLOSURE

Corrosion of metal assets is a serious problem in many industries, including, among others, construction, manufacturing, petroleum and transportation. In the petroleum industry, for instance, corrosion tends to be particularly pervasive and problematic since the industry depends heavily on carbon steel alloys for its metal structures such as pipelines, supplies, equipment, and machinery. The problem of corrosion in such industries can be extremely challenging and costly to assess and remediate due to the harsh and corrosive environments within which the metal structures must exist and operate. Age and the presence of corrosive materials, such as, for example, oxygen (O₂), water (H₂O), hydrogen sulfide (H₂S), carbon-dioxide (CO₂), sulfates, carbonates, sodium chloride, potassium chloride, or microbes in oil and gas production can exacerbate the problem.

Because corrosion of metal assets can be a serious and costly problem to remediate, there has been a significant push in industries to replace metallic assets with nonmetallic alternatives that are resistant to corrosion, thereby cutting corrosion-related costs and increasing revenues. However, the industries have been resistant to such replacements due to the lack of a cost-effective inspection or failure detection technology that can reliably identify and localize aberrations in nonmetallic assets, including failures and mechanical deformations, such as, for example, surface microcracks, propagation of failure, fractures, liquid or gas leaks, among many others. Resultantly, both metallic and nonmetallic assets are commonly employed in the industries without a technology solution that can effectively or efficiently detect and evaluate aberrations in metallic or nonmetallic assets.

Since both metallic and non-metallic assets are commonly used in a variety of industries, there exists a great unfulfilled need for a cost-effective and reliable technology solution for inspecting, detecting, monitoring, analyzing or assessing aberrations in either or both metallic or nonmetallic assets.

### SUMMARY OF THE DISCLOSURE

The instant disclosure provides a cost-effective, reliable technology solution for inspecting, detecting, identifying, monitoring, analyzing or assessing aberrations in ultrasound images of either, or both, metallic or nonmetallic assets, such as, for example, used in the oil and gas industries. The technology solution includes a method, system, apparatus and computer program for inspecting, detecting, monitoring, analyzing or assessing assets using ultrasound imaging, including detecting, identifying, monitoring, analyzing or assessing aberrations in the assets.

According to a non-limiting embodiment of the solution, a computer-implemented method is provided for analyzing a sequence of ultrasound scan images of an asset and diagnosing a health condition of a section of the asset. In this embodiment, the method comprises: receiving, by a machine learning platform, an ultrasound scan image of the section of the asset; analyzing, by the machine learning platform, the ultrasound scan image to detect any aberrations in the section; generating, by the machine learning platform, an aberration label for each detected aberration in the section; labeling, by the machine learning platform, the section of the asset with a section condition label; and, rendering, by a display device, the section conditional label, wherein the section condition label is based on each detected aberration in the section, and wherein the section condition label includes at least one of an aberration area ratio, a total number of aberrations, and the aberration label for each detected aberration in the section of the asset.

The method can comprise: generating a diagnosis of degree of health condition of the section of the asset based on the section condition label; or receiving, by the machine learning platform, an aberration label tuning command; or updating, by the machine learning platform, a parametric value of a machine learning model based on the aberration tuning command; or analyzing, by the machine learning model, another ultrasound scan image of the section of the asset imaged, wherein the ultrasound scan image and said another ultrasound scan image are imaged at different times.

The method can comprise: generating, by the machine learning model, another aberration label for each detected aberration in the section; labeling, by the machine learning model, the section of the asset with another section condition label; and, rendering, by a display device, said another section conditional label, wherein said another section condition label is based on each said another aberration label for each detected aberration in the section, and wherein said section condition label includes at least one of another aberration area ratio, another total number of aberrations, and said another aberration label for each detected aberration in the section of the asset.

In the method, the aberration in the section can include at least one of: a hydrogen induced crack defect; a step-wise crack defect; a hydrogen blister; an inner wall corrosion; a surface crack; and a local thinned area.

In the method, the machine learning platform can be asset agnostic.

In the method, the asset can comprise a metallic material or a composite material.

According to another non-limiting embodiment of the solution, an inspection and assessment system is provided for analyzing a sequence of ultrasound scan images of an asset and diagnosing a health condition of a section of the asset. In the embodiment, the system comprises: an input-output interface arranged to receive an ultrasound scan image of the section of the asset; a feature extraction unit arranged to extract features of an aberration from the ultrasound scan image; a classification unit arranged to classify the aberration based on the extracted features; an aberration predictor unit arranged to analyze the extracted features and classification of the aberration, detect each aberration in the section and determine an aberration type, an aberration dimension or an aberration location for each aberration in the section; a labeler unit arranged to generate a diagnosis of a degree of health of the section and label the section with a section condition label; and an image rendering unit arranged to send an image rendering signal to cause a display device to render the section condition label on the display device with the ultrasound scan image.

In the system, the section condition label can be based on each detected aberration in the section.

In the system, the section condition label can include at least one of an aberration area ratio, a total number of aberrations, and the aberration label for each detected aberration in the section of the asset.

The system can comprise a machine learning platform that includes the feature extraction, classification unit, aberration predictor unit, or labeler unit.

In the system, the machine learning platform can be arranged to: generate, by the machine learning model, another aberration label for each detected aberration in the section; label, by the machine learning model, the section of the asset with another section condition label; and, render, by the display device, said another section conditional label, wherein said another section condition label is based on each said another aberration label for each detected aberration in the section, and wherein said section condition label includes at least one of another aberration area ratio, another total number of aberrations, and said another aberration label for each detected aberration in the section of the asset.

In the system, wherein the aberration in the section can include at least one of: a hydrogen induced crack defect; a step-wise crack defect; a hydrogen blister; an inner wall corrosion; a surface crack; and a local thinned area.

In the system, the machine learning platform can be asset agnostic and the asset can comprise either a metallic material or a composite material.

According to a further non-limiting embodiment of the solution, a non-transitory computer readable storage medium is provided. In the embodiment, the non-transitory computer readable storage medium contains aberration analysis and assessment program instructions for analysis of a sequence of ultrasound scan images of an asset and diagnosis of a health condition of a section of the asset, the program instructions, when executed by a processor, causing the processor to perform an operation comprising: receiving, by a machine learning platform, an ultrasound scan image of the section of the asset; analyzing, by the machine learning platform, the ultrasound scan image to detect any aberrations in the section; generating, by the machine learning platform, an aberration label for each detected aberration in the section; labeling, by the machine learning platform, the section of the asset with a section condition label; and, rendering, by a display device, the section conditional label, wherein the section condition label is based on each detected aberration in the section, and wherein the section condition label includes at least one of an aberration area ratio, a total number of aberrations, and the aberration label for each detected aberration in the section of the asset.

In the non-transitory computer readable storage medium, the aberration in the section can include at least one of: a hydrogen induced crack defect; a step-wise crack defect; a hydrogen blister; an inner wall corrosion; a surface crack; and a local thinned area.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a user environment that includes an embodiment of the technology solution, according to the principles of the disclosure.

FIG. 2 shows an example of a section of the asset in FIG. 1 under observation and for which UT images are captured.

FIG. 3 shows an example of an implementation of an aberration detection and assessment (ADS) system, according to the principles of the disclosure.

FIG. 4 shows an example of a graphic user interface (GUI) that can be generated and displayed on a display device by a computer.

FIG. 5 shows a non-limiting embodiment of the aberration detection and assessment (ADS) system, constructed according to the principles of the disclosure.

FIG. 6 shows a non-limiting embodiment of a training process that can be performed by the ADS system in FIG. 3 or 5, or denoising aberration detection and assessment (DADS) system in FIG. 8.

FIG. 7 shows a non-limiting embodiment of an aberration evaluation process that can be performed by the ADS system in FIG. 3 or 5, DADS system in FIG. 8.

FIG. 8 shows a non-limiting embodiment of the denoised aberration detection and assessment (DADS) system, constructed according to the principles of the disclosure.

FIGS. 9A and 9B show a non-limiting embodiment for a machine learning (ML) model training process, according to the principles of the disclosure.

FIG. 10 shows three views of a non-limiting example of a test section used by the ML training process in FIGS. 9A and 9B.

FIG. 11 shows non-limiting examples of a pair of expected geometries for artificial aberrations that can be generated on the test section used by the ML training process in FIGS. 9A and 9B.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

Assets such as slabs, pipes, pipelines, connectors, joints, tees, bends, valves, nozzles, tanks, and vessels, among other things, are commonly used in many industries like construction, manufacturing, petroleum and transportation. The assets tend to be made of either, or both, metallic or nonmetallic materials. Regardless of the material used in the asset, the asset can include an aberration that can lead to failure of the asset over time, which can occur at the location of the aberration or at a different location as a result of the aberration, such as, for example, at another asset that interacts with or is interdependent with the asset comprising the aberration.

The aberration can include either a harmful or potentially harmful aberration or a benign or harmless aberration. A harmful or potentially harmful aberration can include, for example, a defect, a crack, a hydrogen-induced-cracking (HIC) defect, a step-wise-cracking (SWC) defect, a blister, inner wall corrosion, a surface crack, a surface microcrack, a local thinned area, or any other defect type, including, for example, those specified in the Fitness-For-Service publication, API 579-1/ASME FFS-1, published jointly by The American Society of Mechanical Engineers and the American Petroleum Institute, June, 2016. Some of the questions the API 579 seeks to answer is whether a particular asset can continue to operate and whether it should be de-rated, repaired or replaced. A harmful or potentially harmful aberration can lead to a fracture or leak, or a catastrophic failure in the asset, to name only a few potential conditions that can result over time due to the aberration. As noted earlier, an aberration can exist or develop over time in an asset comprising either metallic or nonmetallic materials.

On the other hand, a benign or harmless aberration can include, for example, an internal defect or void that is commonplace in composite material structures, such as, for example, oil or gas pipelines that include composite materials. Such aberrations do not result in damage or harm to the underlying structure, or the performance or longevity of the structure.

The technology solution provided by this disclosure can effectively and efficiently inspect and analyze ultrasound scan images of either, or both, metallic or nonmetallic assets and detect, identify and assess aberrations in the assets, as well predict failure or damage in the assets as a function of time. The technology solution includes a machine learning platform that can analyze, by a machine learning (ML) model, an ultrasound scan image of an asset, generate an aberration label for each aberration in a section of the asset, generate a section condition label for that section of the asset, and generate a diagnosis that indicates the degree of health of that section of the asset under inspection. The machine learning platform can analyze the ultrasound scan image and determine at least one of an aberration area ratio, a total number of aberrations and an aberration label for each label in the section. The machine learning platform can detect or predict and render each aberration with its respective aberration label, including an aberration type, location and dimensions. Each aberration label can include a determined or predicted location or dimensions of the aberration as a function of time, which can be based on sequence of ultrasound scan images captured of the same section of the asset over time.

A non-limiting embodiment of the solution operates with ultrasonic testing (UT) scan images, such as, for example, those attained by transducer devices placed inside, around or nearby to pipelines that use ultrasonic beams to inspect flaws caused by changes in pipe wall surfaces or pipe wall thickness. The UT images can include UT scans that are generated by, for example, pulse-echo transducer devices, pitch-catch transducer devices, phased array transducer devices, composite transducer array devices, or any other type of transducer device or technology capable of capturing ultrasound images of assets. The solution can analyze the UT scan images and detect or predict aberrations in the areas under observation, whether it be in metallic or nonmetallic assets, including, for example, assets containing composite materials, such as, for example, glass fiber-based composites, epoxy resin-based composites, or fiberglass-reinforced plastic (FRP) composites. The solution satisfies an urgent and unmet need for a mechanism that can effectively, efficiently and accurately predict damage or failure in assets, regardless of whether the assets are made of a metallic or nonmetallic material, such as, for example, a composite material. The solution can analyze UT images and detect an aberration in an area of an asset under observation in the images. The solution can, based on the characteristics or parameters of the aberration, and predict failure or long-term damage to the asset that can result from or due to the aberration.

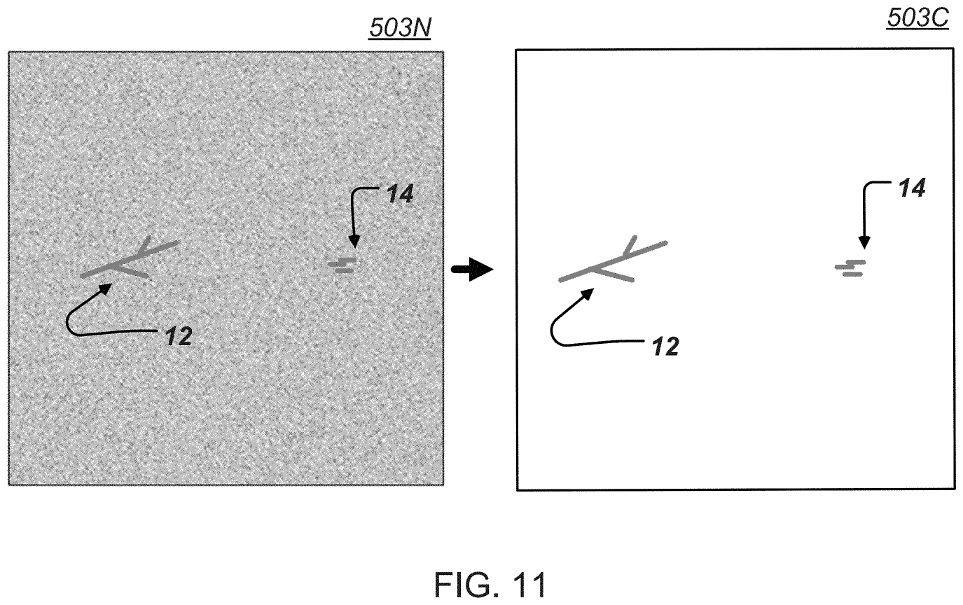

In a non-limiting embodiment, the solution can work with UT scan image data, such as, for example, C-scan image data. The UT image data can include, for example, A-scan ultrasound image, B-scan ultrasound image data, 0-degree advanced C-scan image data, angled C-scan image data, or D-scan ultrasound image data. The solution can be asset-material-agnostic. That is, the solution can be agnostic of the type of material under observation, and the solution need not be concerned with whether the images are from a metal or a composite material but can work well with either, so long as the UT images are clear. This embodiment of the solution can work especially well with UT images of assets containing metallic or high quality composite materials. However, the embodiment might provide less than optimal performance if the UT images are less clear, as can sometimes occur when investigating assets made of composite materials that are of lower quality and, resultantly, have many benign aberrations that, due to resulting signal attenuation, show up as noise in the UT images (for example, noisy UT image 503N, shown in FIG. 11).

In another non-limiting embodiment, the solution includes a denoising solution that can provide optimal performance for inspection of assets that contain composite materials, such as, for example, those commonly used in oil or gas industry pipelines. The denoising solution can be arranged to filter out noise that can result from benign aberrations, such as, for example, air pockets, blemishes or other benign aberrations that do not materially affect the asset or its health, performance or longevity. Since in many practical applications clear UT images of composite materials can be difficult to obtain, the denoising solution can operate to remove noise from such UT images (for example, noisy UT image 503N, shown in FIG. 11) to produce clear UT C-scan images (for example, clear UT image 503C, shown in FIG. 11), which can then be effectively and efficiently inspected and analyzed by the solution to detect or predict aberrations in the assets under observation and generate a diagnosis of the health of the asset. The denoising solution can be used with existing UT images, such as, for example, those captured by tried and tested non-destructive-testing (NDT) UT transducers, to produce clear, high quality UT image data that can be used to detect, identify, analyze and assess aberrations that would otherwise have gone undetected by state-of-the art methodologies.

Fitness for service engineering evaluation procedures have been used in industries such as oil and gas for a long time. In the petroleum industry, for example, the procedure is commonly known as Fitness-For-Service (or “FFS”); whereas in the gas pipeline industry the procedure is commonly known by the standard-setting body's publication ASME B31.G. The American Petroleum Institute (API) and the American Society of Mechanical Engineers (ASME) have jointly published a document they identified as API RP 579-1/ASME FFS-1, which summarizes a Fitness-For-Service assessment standard used by the oil and gas industries. The publication provides the refining and petrochemical industries with a compendium of consensus methods for assessing the structural integrity of equipment containing identified flaws or damage. The API RP 579 was written to be used in conjunction with the refining and petrochemical industries' existing codes for pressure vessels, piping and aboveground storage tanks (API 510, API 570 and API 653). The standardized Fitness-For-Service assessment procedures presented in API RP 579 provide technically sound consensus approaches that ensure the safety of plant personnel and the public while aging equipment continues to operate, and can be used to optimize maintenance and operation practices, maintain availability and enhance the long-term economic performance of plant equipment.

Ultrasound (UT) scan imaging is commonly used for non-destructive testing and evaluation, and structural health monitoring of structural assets in FFS assessments. Because of its excellent long-range diagnostic capability, ultrasound can be effective in detecting and assessing the condition of an asset for aberrations such as, for example, among other things, brittle factures, cracks, crack-like flaws, metal loss, pitting corrosion, hydrogen blisters, HIC, SWC, weld misalignments, shell distortions, dents, gauges, or other damage, defects or flaws. However, in practical applications the UT scan images of a single asset under observation can include large numbers of aberrations, especially where the asset comprises a lower quality composite material, thereby necessitating highly trained human users to spend significant amounts of time to analyze each individual scan and characterize the aberration, quantify the characteristics or extent of the aberration and distinguish between different types of aberrations. This process can be extremely tedious, lengthy, resource-intensive, and prone to human error as inconsistencies can arise from human judgments of different operators. For example, UT images of damaged assets can contain a large number of aberrations, thereby making it extremely difficult and time-consuming for highly trained human users to analyze each individual UT image, characterize the aberration, quantify the extent of damage and distinguish between, for example, an HIC or SWC type of aberration. Hence, in mature field or plant operations that include large numbers of assets or span expansive geographical areas, the need for timely assessment of assets can quickly outpace available human resources, thereby risking catastrophic conditions where critical assets might fail if not timely replaced or repaired. The solution addresses such needs by providing a technology platform that can minimize or eliminate the need for human intervention in detecting and assessing aberrations.

The technology solution provided by this disclosure includes a fully-automated solution that can effectively and efficiently detect, monitor, identify, analyze or assess aberrations in assets, regardless of the scale or number of assets or amounts of UT images in need of analysis and assessment. The solution includes a machine learning platform that can implement a machine learning (ML) model to analyze large numbers of UT scan images and monitor, detect or identify aberrations in each section of an asset. The solution can, based on its analysis of the aberrations in a section of the asset, assess characteristics of each aberration in that section and determine or diagnose a degree of health or health condition of that section. The solution can generate an aberration label for each detected or predicted aberration in that section of the asset, including the aberration type (for example, is it an HIC or SWC?), location(s) (for example, x, y, z Cartesian coordinates) of the aberration and dimensions (for example, height, width, length, depth, diameter) of the aberration. The solution can generate a section condition label for that section, which can be based each aberration label for that section. The section condition label can include an aberration area ratio and the total number of aberrations in that section, as well as each aberration label for that section. The machine learning platform can, by the ML model, analyze the UT images and assess aberrations in the asset under observation. The solution can predict an aberration over its entire life cycle, from its initial formation through its development, and ultimately the resultant damage or failure of the affected asset that might occur if not mitigated.

The solution can build or store a training dataset for the machine learning platform. The training dataset can be input to the machine learning platform to build the ML model, or to tune the ML model by updating parametric values in the model, including, for example, hyper-parameter tuning, depending on the input UT images. The solution can include a feedback mechanism to the machine learning platform to tune the model parameters as the solution operates on input UT images for an asset under observation. The feedback mechanism can include a label tuning command that is generated during interaction with an operator, such as, for example, a command signal from a graphic user interface (GUI).

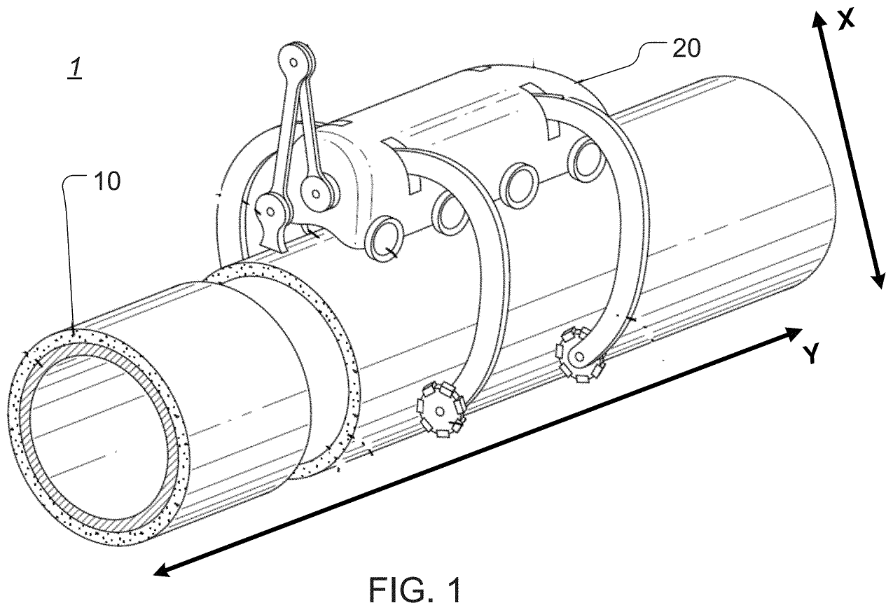

FIG. 1 shows a non-limiting example of a user environment 1 that can include an embodiment of the technology solution, according to the principles of the disclosure. The environment 1 includes an asset 10 and a non-destructive-evaluation (NDE) transducer 20 that can be arranged to investigate or monitor one or more sections, or the entire asset 10 by emitting or capturing ultrasound energy reflecting from or passing through a section of the asset 10 under observation. The NDE transducer 20 can be arranged to capture and record ultrasonic (UT) images of the asset 10 over extended periods of time, which can be utilized for monitoring purposes to detect, identify and monitor aberrations in the asset 10, such as, for example, to detect when aberrations occur, identify the type of aberration and monitor the aberration as it develops over its life cycle.

The asset 10 can include a metallic or nonmetallic material, such as, for example, a low quality composite material used in pipelines or a very high quality composite material used in aerospace applications, or any other composite material used in assets such as those found in manufacturing, wastewater treatment, utilities, plants, factories, pipelines, or oil and gas industries. In the non-limiting example shown in FIG. 1, the asset 10 includes a pipeline structure that includes either or both metallic or nonmetallic materials; in the latter case, the nonmetallic materials include composite materials. The asset 10 can include any structure, including, for example, a pipe, a tee, a joint, a bend, a nozzle, a vessel, a valve, or a connector.

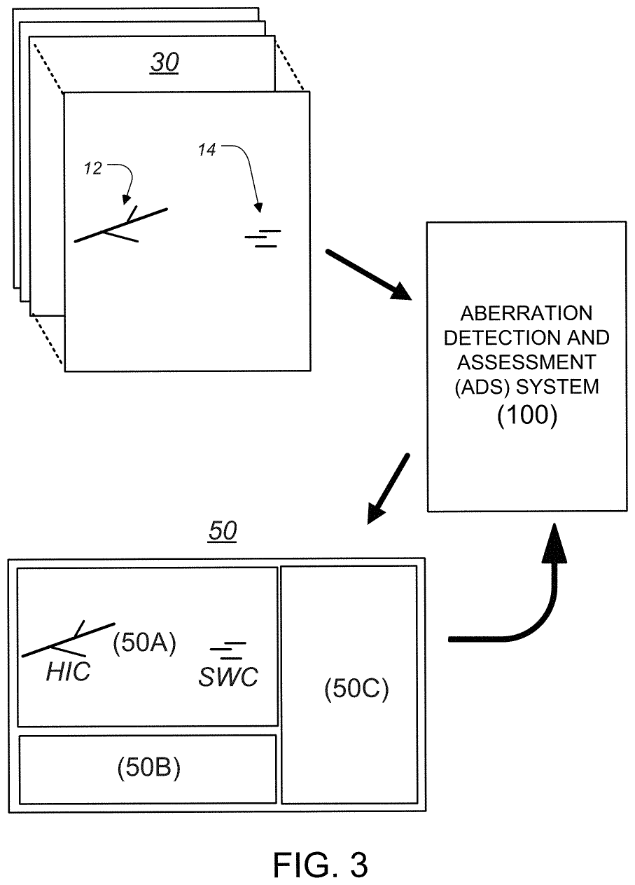

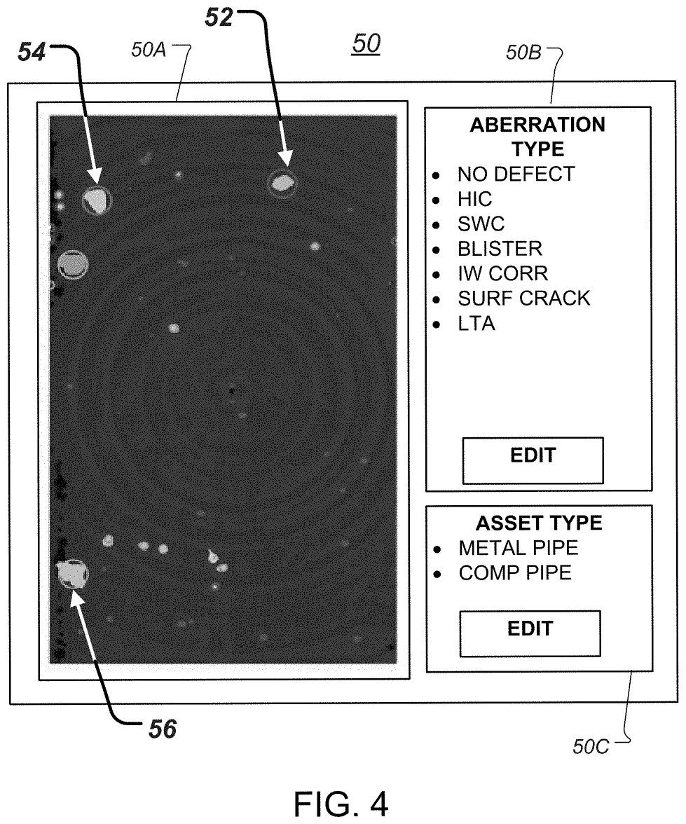

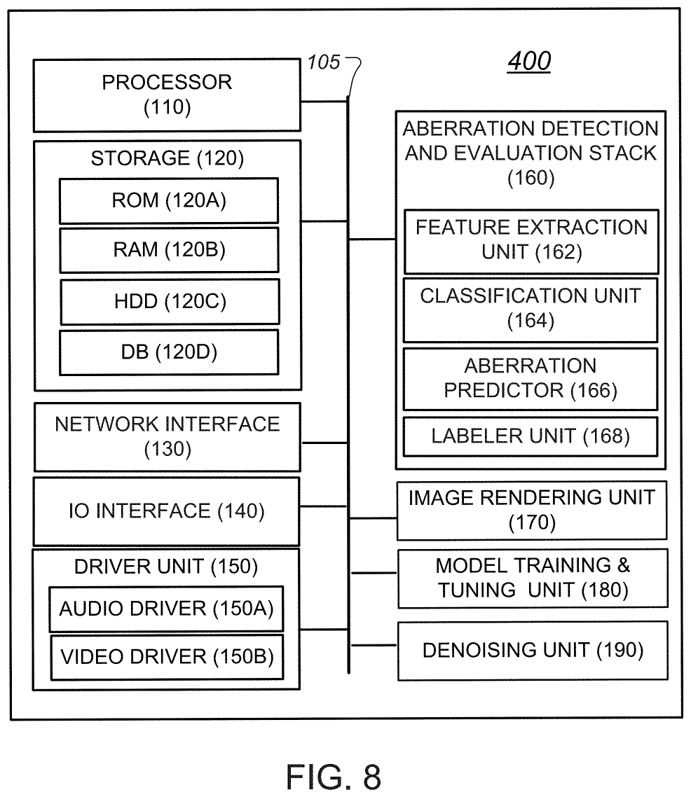

The NDE transducer 20 can include an ultrasound transducer device (not shown), such as, for example, a straight beam transducer, an angle beam transducer, a multi-element transducer, a delay line transducer, an immersion transducer, or any other type of transducer capable of emitting or capturing ultrasonic scan data of an area of the asset 10 under observation. The ultrasound transducer device (not shown) can be positioned on the NDE transducer 20 and arranged to scan the asset 10 one section at a time, for example, along its longitudinal axis (Y-axis) and transverse axis (X-axis), which in this example is around the diameter of the pipe, perpendicular to the Y-axis. The NDE transducer 20 can include a computing device or a communicating device. The ultrasound transducer device (not shown) can be arranged to use any combination of, for example, straight or direct beam ultrasound energy or angular-beam ultrasound energy. The NDE transducer 20 can be arranged to scan an area of the asset 10 under observation and capture a resultant sequence of UT scan images, including, for example an ultrasound testing (UT) scan file for a unique section (or area) of the asset 10. The UT scan images can be stitched together by compositing the sequence of UT scan images to form a composite UT image of the asset 10. The NDE transducer 20 can be arranged to capture and record each UT scan image of a section of the asset 10 as a UT scan file, having a multidimensional array of pixels—for example, a two-dimensional (2D) image array or a three-dimensional (3D) image array of pixels. The NDE transducer 20 can include, or it can be arranged to communicate with the technology solution provided by this disclosure, including, for instance, an aberration detection and assessment (ADS) system 100 (shown in FIGS. 3 and 4) or denoising aberration detection and assessment (DADS) system 400 (shown in FIG. 8). The NDE transducer 20 can be arranged to communicate with the solution via a communication link, which can include a communication link over a network (not shown).

The ultrasound transducer device (not shown) can include a stand-alone device that can be positioned, for example, manually, to capture UT images of a section of the asset 10 as a function of time, or it can be included on a movable tool, such as, for example, the NDE transducer 20 (shown in FIG. 1). The NDE transducer 20 can include, for example, the inspection crawler 102 described in U.S. Pat. No. 10,589,433. The NDE transducer 20 can include any device capable of moving in, on, or about a section of the asset 10 as it captures or records UT images of the asset 10.

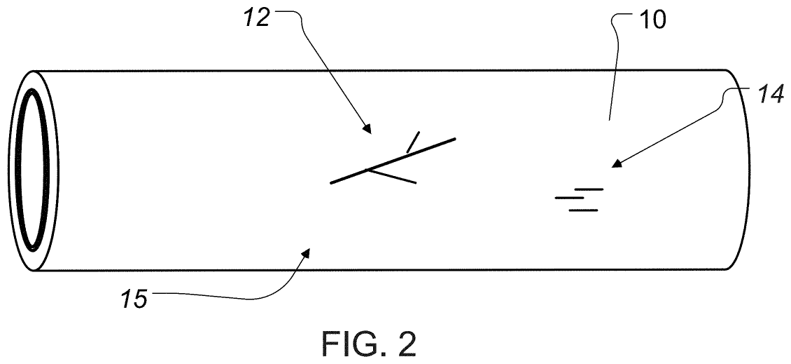

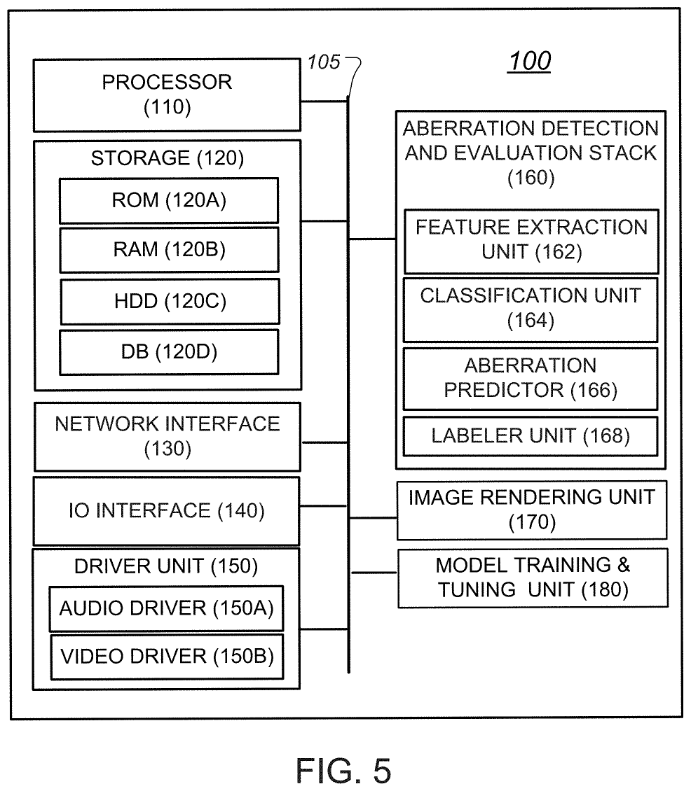

FIG. 2 shows a non-limiting example of a section 15 of the asset 10 that is under observation and for which UT images are captured or recorded by the NDE transducer 20. In this example, the section 15 is shown as including two aberrations—a hydrogen-induced-crack (HIC) 12 and a step-wise-crack (SWC) 14. The NDE transducer 20 can capture a plurality of UT image frames 30 (shown in FIG. 3) of the section 15 over time. In this regard, each UT image frame 30 can include a unique UT scan file for the images captured by the NDE transducer 20. The scanning rate can be maintained such that no blurring occurs in the resultant UT image, by allowing enough time for the ultrasound waves to propagate through the asset material and to the ultrasound transducer device (not shown). The UT image frames 30 can be stored locally in or converted to digital format, or output to the ADS system 100, shown in FIG. 5 (or DADS system 400, shown in FIG. 8) as analog signals, in which case the UT images can be digitized by the ADS system 100.

FIG. 3 shows a non-limiting example of an implementation of the ADS system 100, shown in FIG. 5 (or DADS system 400, shown in FIG. 8) with the UT image frames 30 received from the NDE transducer 20 (shown in FIG. 1). The UT image frames 30 can be communicated from the NDE transducer 20 to an input of the ADS system 100 as analog or digital signals. The received UT image data can be analyzed by the machine learning platform to detect or predict any aberrations, and to identify and assess any determined aberrations in the asset 10, such as, for example, the HIC 12 and SWC 14 in section 15 of the asset 10 (shown in FIG. 2). The machine learning platform can analyze the UT image data and predict formation or development of the aberrations 12, 14, including development of the aberrations to their respective end-of-life-cycles, which might include damage or failure of the asset 10 due to the aberrations.

The ADS system 100 (or DADS system 400, shown in FIG. 8) can be arranged to communicate an image rendering signal to a computer 50, which can cause the computer 50 to render a graphic user interface (GUI) comprising one or more display regions (for example, 50A, 50B, 50C). The image rendering signal can include data or commands the computer 50 can use to reproduce the UT image, including a rendering of the section 15 under inspection, in the display region 50A together with one or more annotation display regions 50B, 50C. The image rendered in the display region 50A can include the UT image of the section 15, including all aberrations that are detected or predicted in that section of the asset 10.

An aberration label can be included in the image rending signal for each aberration in the section 15. The display device (for example, shown in FIG. 3 or) can, in response to the image rendering signal, display each aberration on the UT image along with its respective aberration label, including the type of aberration (for example, HIC or SWC), the aberration's location, and the aberration's dimensions.

The image rendering signal can include a section condition label for the section 15. The section condition label can be based on each determined aberration in the section 15. The section condition label can include an aberration area ratio, the total number of aberrations in the section 15, as well as the aberration label for each aberration in the section 15. The display device can, in response to the image rendering signal, display the section condition label for the section 15. The section condition label can additionally include, for example, the dimensions of the section 15, the physical location of the section 15, the material contained in the section 15, or any characteristic that can be utilized in assessing the location and condition of the section 15.

The annotation display regions 50B or 50C can include, for example, a list of aberration types that might exist in the particular type of asset 10 under observation. For instance, the list of aberrations in display region 50C for the section 15 can include, for example, “no defect”, “HIC defect”, “SWC defect”, “blister”, “inner wall corrosion”, “surface crack”, “local thinned area”, among others. The display regions 50B or 50C can include a list of asset types that can be investigated by the ADS system 100, such as, for example, a metallic oil pipeline, a composite nonmetallic oil pipeline, or a hybrid-composite-metallic oil pipeline having composite pipe with metallic joints. The display regions 50B or 50C can display the aberration label for each aberration on the section 15 and the section condition label for that section.

In this non-limiting example, the UT image of the section 15 can be rendered in the display region 50A, including all aberrations that are detected or predicted in the section 15, and an aberration label for each aberration that identifies, as determined by the ADS system 100, the type of aberration, its dimensions and location(s). The section condition label can also be rendered with the UT image, including the aberration area ratio and the total number of aberrations in the section 15. Each aberration can be rendered such that the displayed image accurately depicts or predicts the size, shape, and location of the aberration.

In the non-limiting example in FIGS. 2 and 3, the ADS system 100 has detected or predicted the aberrations 12 and 14 for the section 15. In this example, the machine learning platform in the ADS system 100 has analyzing the UT images received from the NDE transducer 20 (shown in FIG. 1), detected or predicted the aberrations 12 and 14, and determined the aberrations 12 and 14 are HIC and SWC defects, respectively. Based on the aberration types, dimensions and location, the ADS system 100 has diagnosed the aberrations 12 and 14 as non-severe and non-critical and the overall degree of health for the section 15 to be high, thereby necessitating continued monitoring but not immediate repair or replacement of the section 15. The ADS system 100 has generated the aberration label for each of the pair of aberrations, including the aberration type, location(s), and dimensions, as well as the section condition label for the section 15, including the aberration area ratio and the number of number of aberrations in the section.

FIG. 4 shows a non-limiting example of a GUI that can be generated and displayed on the display device of the computer 50 in response to the image rendering signal from the ADS system 100, or by the video driver 150B under operation of the processor 110 (shown in FIG. 5). As seen in FIG. 4, based on image rendering commands or data in the received image rendering signal, the GUI can display a UT image frame in the display region 50A that was captured by the NDE transducer 20 (shown in FIG. 1) and analyzed by the ADS system 100, together with a label for each aberration type. The GUI can generate and display an aberration type list and an asset type list in, for example, display regions 50B and 50C, respectively, based on the commands or data in the image rendering signal. The GUI can be arranged to receive annotation commands or annotation data from a user via an input-out interface, such as, for example, a touch-screen display, a keyboard, a mouse, or any other user interface (UI) or human-user-interface (HMI). The annotation commands or annotation data input to the GUI by the user can be packaged and communicated to the ADS system 100, where the annotation commands or annotation data can be used by the ADS system 100 to build or train a machine learning (ML) model or to tune the parametric values in the ML model after it has been built and trained. The ML model can be arranged to more accurately detect or predict aberrations in UT image data with each successive UT image frame received by the ADS system 100, including the type or characteristics of each aberration, including its dimensions, shape, or location(s).

Referring to FIG. 4, a user can select the aberration 52, 54 or 56 on the display region 50A, for example, by touching the display screen or selecting the aberration or aberration label using a mouse or stylus (not shown) and then selecting an edit function (for example, “EDIT” radio button) on the display region 50B to change or assign the aberration type, dimensions or location to the selected aberration 52, 54, or 56 in the UT image rendered on the display region 50A. For example, the user can select aberration 52 in display region 50A and then select “HIC” in display region 50B to correct (or create) the label for the rendered aberration 52. The user can select the aberration 54 and then select “no defect” if the user determines after investigation that the aberration 54 corresponds to a benign or harmless aberration. A label tuning command can be generated, for example, by the computer 50 or ADS system 100, based on the user selections or annotations and input to the machine learning platform to train or tune the ML model, including for example, updating the parametric values in the ML model based on operator feedback.

Accordingly, through interaction with the computer 50 (or an operator via IO interface 140, shown in FIG. 5), the ADS system 100 can create or update parametric values in the ML model for each aberration on the section 15, generate a list of aberrations in each UT image and label each aberration in the section with a corresponding aberration label. The ADS system 100 can be arranged to communicate the aberration labels and section condition label to the computer 50 for rendering on the display device, or cause the aberration labels and section condition label to be rendered on another display device (not shown) directly via the video driver 150B under operation of the processor 110 or image rendering unit 170 (shown in FIG. 5). The aberration labels can be edited by the user, for example, at the computer 50, and the edits communicated back as label tuning commands to the ADS system 100 to train or tune the parametric values in the ML model. The feedback mechanism provided by the label tuning commands allows the ADS system 100, in which the ML model classifies the various regions of the UT image into different aberration categories, to modify the classified results and evaluated categories based on additional user input, and generate a diagnosis that indicates a degree of health of the section, and that can predict the degree of health of the section as a function of time.

FIG. 5 shows a non-limiting embodiment of the ADS system 100, constructed according to the principles of the disclosure. The ADS system 100 can include at least one machine learning platform. The ADS system 100 includes a bus 105, a processor 110 and a storage 120. The ADS system 100 can include a network interface 130, an input-output (10) interface 140, a driver unit 150, an aberration detection and evaluation (ADE) stack 160, an image rendering unit 170, or a machine-learning (ML) model training and tuning (MTT) unit 180, which can include parametric tuning of the parameters in the ML model. Each of the computer resource assets 105 to 180 can be connected to a communication link. Although shown as a plurality of separate devices, the computer resource assets 110 to 180 can be integrated to form fewer than the number of devices seen in FIG. 5. For instance, in a non-limiting embodiment, the driver unit 150, ADE stack 160, image rendering unit 170, or MTT unit 180 can be provided in a machine learning platform as separate computer resources that are executable as computer resource processes on the processor 110. Any one or more of the computer resource assets 120 to 180 can include a computing device or a computing resource that is separate from the processor 110, as seen in FIG. 5, or integrated or integrateable or executable on a computing device such as the processor 110.

The ADE stack 160 can include a feature extraction unit 162, a classification unit 164, an aberration predictor 166, and a labeler unit 168. The ADE stack 160 can include a machine learning (ML) platform, including, for example, one or more feedforward or feedback neural networks. The ML platform can include, for example, an artificial neural network (ANN), a convolutional neural network (CNN), a deep convolutional neural network (DCNN), a recurrent convolutional neural network (RCNN), a Mask-RCNN, a deep convolutional encoder-decoder (DCED), a recurrent neural network (RNN), a neural Turing machine (NTM), a differential neural computer (DNC), a support vector machine (SVM), or a deep learning neural network (DLNN). The ML platform can include the ML model for the ADE stack 160. Alternatively, the ML platform can include the ADE stack 160, image rending unit 170 and MTT unit 180.

The ADE stack 160 can analyze UT images of the asset 10 (shown in FIG. 1), detect one or more aberrations in the section 15 of the asset 10, classify and identify each of the one or more aberrations, and generate an aberration label for each aberration, including the type of aberration, the location of the aberration and the dimensions of the aberration. The ADE stack 160 can generate a section condition label for the section 15, including the aberration area ratio and the total number of aberrations in the section. The ADE stack 160 can determine the number of detected or predicted aberrations for the section 15 and include the total number of aberrations in the section condition label for that section. Based on the analysis of the UT images, the ADE stack 160 can detect or predict each aberration in the section 15, the aberration's dimensions, shape, location and aberration type, as well as the overall aberration area ratio and total number of aberrations in the section 15. The ADE stack 160 can detect or predict each aberration over its life cycle, from its initial formation through its development and, if unmitigated, completion or finish as a function of time, including, for example, failure of, or damage to underlying structure of the section 15. The ADE stack 160 can generate, by the labeler unit 168, a diagnosis of the health condition of the section 15, including a degree of health condition of the section 15. The degree of health condition can include, for example, (i) non-critical or non-harmful aberration that necessitates follow up investigation, (ii) initial or mild damage that necessitates continued observation or monitoring, (iii) moderate damage that necessitates detailed investigation, (iv) high damage that necessitates repair, or (v) critical damage that necessitates replacement of the section 5.

The processor 110 can include any of various commercially available computing devices, including for example, a central processing unit (CPU), a graphic processing unit (GPU), a general-purpose GPU (GPGPU), a field programmable gate array (FGPA), an application-specific integrated circuit (ASIC), a many core processor, multiple microprocessors, or any other computing device architecture can be included in the processor 110.

The ADS system 100 can include a non-transitory computer-readable storage medium that can hold executable or interpretable computer program code or instructions that, when executed by the processor 110 or one or more computer resource assets in the ADS system 100, causes the steps, processes or methods in this disclosure to be carried out. The computer-readable storage medium can be included in the storage 120.

The storage 120, including any non-transitory computer-readable media, can provide nonvolatile storage of data, data structures, and computer-executable instructions. The storage 120 can accommodate the storage of any data in a suitable digital format. The storage 120 can include one or more computing resources, such as, for example, program modules or software applications that can be used to execute aspects of the architecture included in this disclosure. The storage 120 can include a read-only-memory (ROM) 120A, a random-access-memory (RAM) 110B, a disk drive (DD) 120C, and a database (DB) 120D.

A basic input-output system (BIOS) can be stored in the non-volatile memory 120A, which can include a ROM, such as, for example, an erasable programmable read-only memory (EPROM), an electrically erasable programmable read-only memory (EEPROM) or another type of non-volatile memory. The BIOS can contain the basic routines that help to transfer information between the computer resource assets in the ADS system 100, such as during start-up.

The RAM 120B can include a high-speed RAM such as static RAM for caching data. The RAM 120B can include, for example, a static random access memory (SRAM), a dynamic random access memory (DRAM), a synchronous DRAM (SDRAM), a non-volatile RAM (NVRAM) or any other high-speed memory that can be adapted to cache data in the ADS system 100.

The DD 120C can include a hard disk drive (HDD), an enhanced integrated drive electronics (EIDE) drive, a solid-state drive (SSD), a serial advanced technology attachments (SATA) drive, or an optical disk drive (ODD). The DD 120C can be arranged for external use in a suitable chassis (not shown). The DD 120C can be connected to the bus 105 by a hard disk drive interface (not shown) or an optical drive interface (not shown), respectively. The hard disk drive interface (not shown) can include a Universal Serial Bus (USB) (not shown), an IEEE 1394 interface (not shown), or any other suitable interface for external applications. The DD 120C can include the computing resources for the ADE stack 160. The DD 120C can be arranged to store data relating to instantiated processes (including, for example, instantiated process name, instantiated process identification number and instantiated process canonical path), process instantiation verification data (including, for example, process name, identification number and canonical path), timestamps, incident or event notifications.

The database (DB) 120D can be arranged to store UT images in digital format, including UT image frames 30 (shown in FIG. 3) for the environment 1 (shown in FIG. 1). The DB 120D can include an inventory of all assets 10 in the environment 1, including the age of each asset, a history of any repairs or damage to the asset, operational status, or any information that can help in assessing or predicting the condition of the asset as a function of time by the ADS system 100. The DB 120D can include a record for each asset 10 in the environment 1. The DB 120D can include a record for each section of the asset 10, including a section condition label. The DB 120D can include a record for each aberration, including an aberration label for each aberration. The DB 120D can include a training dataset that can be used to train the ML model in the ADS system 100. The DB 120D can include a testing dataset that can be used to train the ML model. The DB 120D can include a baseline dataset that can be used to build the training dataset.

The DB 120D can be arranged to be accessed by any of the computer resource assets 105 to 180. The DB 120 D can be arranged to receive queries and, in response, retrieve specific records or portions of records based on the queries and send any retrieved data to the computer resource asset from which the query was received, or to another computer resource asset at the instruction of the originating computer resource asset. The DB 120D can include a database management systems (DBMS) that can interact with the computer resource assets 105 to 180. The DBMS can be arranged to interact with computer resource assets outside of the ADS system 100, such as, for example, the computer 50 (shown in FIGS. 3 and 4). The DBMS can include, for example, SQL, MySQL, Oracle, Postgress, Access, or Unix. The DB 120D can include a relational database.

One or more computing resources can be stored in the storage 120, including, for example, an operating system (OS), an application program, an application program interface (API), a program module, or program data. The computing resource can include an API such as, for example, a web API, a Simple Object Access Protocol (SOAP) API, a Remote Procedure Call (RPC) API, a Representational State Transfer (REST) API, or any other utility or service API. One or more of the computing resources can be cached in the RAM 120B as executable sections of computer program code or retrievable data.

The network interface 130 can be arranged to connect to a computer resource asset (for example, computer 50, shown in FIG. 3) on a network (not shown), such as, for example, a local area network (LAN) or an external network, such as, for example, the Internet. The network interface 130 can connect to the computer resource asset via a wired or a wireless communication network interface (not shown) or a modem (not shown). When used in a LAN, the ADS system 100 can be arranged to connect to the LAN through the wired or wireless communication network interface; and, when used in a wide area network (WAN), the ADS system 100 can be arranged to connect to the WAN network through the modem. The modem (not shown) can be internal or external and wired or wireless. The modem can be connected to the bus 105 via, for example, a serial port interface (not shown).

The IO interface 140 can receive commands or data from an operator or an external computer resource asset, including, for example, the ultrasound transducer device (not shown) included in the NDE transducer 20 (shown in FIG. 1). The IO interface 140 can be arranged to connect to or communicate with one or more input-output devices (not shown), including, for example, a keyboard (not shown), a mouse (not shown), a pointer (not shown), a microphone (not shown), a speaker (not shown), or a display (not shown). The IO interface 140 can include an HMI. The received commands or data can be forwarded from the IO interface 140 as instruction or data signals via the bus 105 to any computer resource asset in the ADS system 100. The IO interface 140 can include a receiver (not shown), a transmitter (not shown) or a transceiver (not shown).

The driver unit 150 can include an audio driver 150A and a video driver 150B. The audio driver 150A can include a sound card, a sound driver (not shown), an interactive voice response (IVR) unit, or any other device that can render a sound signal on a sound production device (not shown), such as for example, a speaker (not shown). The video driver 150B can include a video card (not shown), a graphics driver (not shown), a video adaptor (not shown), or any other device necessary to render an image signal on a display device (not shown).

In the ADE stack 160, the feature extraction unit 162 can be arranged to extract features from the received UT image data for the asset 10. The feature extraction unit 162 can interact with the aberration predictor 164. The extracted features can be compared to model or healthy features for the same or similar asset as the asset 10. The feature extraction unit 162 can be arranged to extract features from sequences of UT image frames, so as to extract features for the asset under observation as a function of time. Features related to aberrations in the UT image data can be extracted using a pixel-by-pixel comparative analysis of the UT image data for the asset 10 under inspection with known or expected features (reference features), including reference features from a controlled or clean asset. For instance, features relating to a characteristic of an aberration, such as, for example, a dimension (for example, width, length, depth, height, radius, diameter), a location (for example, Cartesian coordinates x, y, z), or a shape (for example, a hair-line fracture, a pin-hole, or a circular indent) can be compared to the features of a corresponding characteristic of a non-damaged asset. This allows the ADE stack 160 to populate the DB 120D with historical data that can be used to train or tune the ML model to detect, identify, assess or predict aberrations that might exist or develop in the asset 10 and to generate a diagnosis of the degree of health of the asset 10.

In a non-limiting embodiment, the ADE stack 160 includes a CNN or DCNN, in which case the ADE stack 160 can analyze every pixel in the UT image data (for example, by the feature extraction unit 162), classify the image data (for example, by the classification unit 164) and make a prediction at every pixel (for example, the aberration predictor 166) regarding the presence of an aberration. In this regard, the UT image data can be formatted by the feature extractor unit 162 into h×c pixel matrix data, where h is the number of rows of pixels in a pixel matrix and c is the number of columns of pixels in the same pixel matrix. After formatting the UT image data into h×c pixel matrices, the feature extraction unit 162 can filter (or convolute) each pixel matrix using an a×a pixel grid filter matrix, where a is greater than 1 but less than h or c. According to a non-limiting embodiment, a=2 pixels. The feature extraction unit 162 can slide and apply one or more a×a filter matrices (or grids) across all pixels in each h×c pixel matrix to compute dot products and detect patterns, creating convolved feature matrices having the same size as the a×a filter matrix. The feature extraction unit 162 can slide and apply multiple filter matrices to each h×c pixel matrix to extract a plurality of feature maps of the UT image data for the asset 10 under inspection.

Once the feature maps are extracted, the feature maps can be moved to one or more rectified linear unit layers (ReLUs) in a CNN to locate the features. After the features are located, the rectified feature maps can be moved to one or more pooling layers to down-sample and reduce the dimensionality of each feature map. The down-sampled data can be output as multidimensional data arrays, such as, for example, a two-dimensional (2D) array or a three-dimensional (3D) array. The resultant multidimensional data arrays output from the pooling layers can be flattened (or converted) into single continuous linear vectors that can be forwarded to the fully connected layer. The flattened matrices from the pooling layer can be fed as inputs to the classification unit 164 or aberration predictor 166.

The classification unit 164 can include a fully connected neural network layer, such as, which can auto-encode the feature data from the feature extraction unit 162 and classify the image data. The classification unit 164 can include a fully connected layer that contains a plurality of hidden layers and an output layer. The output layer can output the classification data to the aberration predictor 166.

The aberration predictor 166 can be arranged to receive the resultant image cells and predict aberrations that might exist in the asset 10, including, for example, on an outer surface, in a wall portion, or an inner surface of the asset 10. The aberration predictor 166 can generate a confidence score for each image cell that indicates the likelihood that a bounding box includes an aberration. The aberration predictor 166 can interact with the classification unit 164 and perform bounding box classification, refinement and scoring based on the aberrations in the image represented by the UT image data. The aberration predictor 166 can determine location data such as, for example, x-y-z Cartesian coordinates with respect to the asset 10. The location data can be determined for the aberration and the bounding box. Dimensions (for example, height, width, length, depth, radius, diameter), shape, geospatial orientation (for example, angular position or attitude) and location of the aberration can be determined, and probability data that indicates the likelihood that a given bounding box contains or will develop the aberration can be determined by the aberration predictor 166. The aberration predictor 166 can be arranged to determine a prediction score that indicates the likelihood that an aberration exists or will develop over time on the asset. The prediction score can range from, for example, 0% to 100%, with 100% being a detected aberration, and 0% to 99.99% being a prediction that an aberration exists or will develop in a highlighted area on the asset 10.

In the ADE stack 160, the feature extraction unit 162, classification unit 164 and aberration predictor 166 can be implemented using one or more CNNs having a number of convolutional/pooling layers (for example, 1 or 2 convolutional/pooling layers) and a single fully connected layer, or it can be implemented using a DCNN having many convolutional/pooling layers (for example, 10, 12, 14, 20, 26, or more layers) followed by multiple fully connected layers (for example, two or more fully connected layers). The ADE stack 160 can include an RNN, such as, for example, a single stack RNN or a complex multi-stack RNN. The CNN can be applied to stratify the received UT image data into abstraction levels according to an image topology, and the RNN can be applied to detect patterns in the images over time. The ADE stack 160 can detect areas of interest and aberrations that might exist or develop over time in the asset 10, as well as capture the creation or evolution of the aberration as it develops over time.

The labeler unit 168 can be arranged to (for example, together with the feature extraction unit 162, classification unit 164, and aberration predictor 166) receive and analyze UT image data, and detect, identify, assess or predict an aberration and its location in the asset 10. The ADE stack 160 can analyze sequences of UT images of a section or the entire asset 10 captured by the NDE transducer 20 (shown in FIG. 1) over a period of time, which can range anywhere from milliseconds to seconds, minutes, hours, days, weeks, months, or years, depending on the application. The labeler unit 168 can, based on the results of the UT image analysis, determine an aberration area ratio, the number of aberrations, and the size, location and type of each aberration on the section under observation (for example, section 15, shown in FIG. 2) as a function of time and annotate each aberration with a corresponding aberration label, and annotate the section with a corresponding section condition label.

The ADE stack 160 can interact with the image rendering unit 170, which can be arranged to generate image rendering commands or data that can be used by, or cause a computer resource asset, such as, for example, the computer 50 (shown in FIGS. 3 and 4), to render the UT images with aberration labels and section condition label on the display device, as discussed above, with respect to FIGS. 3 and 4. The rendered section condition label can include the type of asset material, the aberration area ratio, the total number of aberrations and the aberration label for each rendered aberration in the UT image, including the type of aberration, the shape of the aberration, the location of the aberration, and the dimensions of the aberration, or any other information that can facilitate in evaluating the condition, health or longevity of the section under investigation.

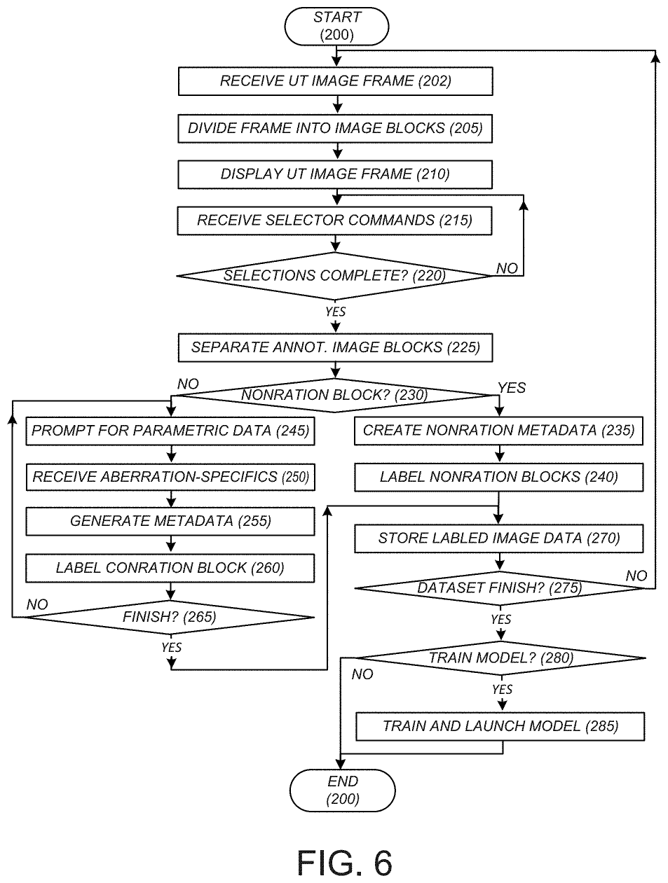

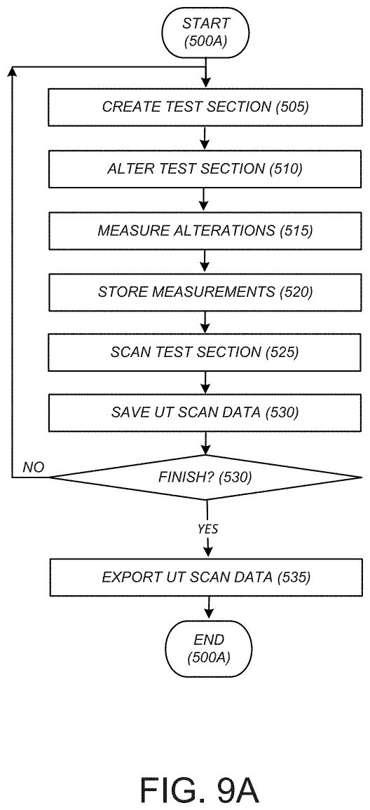

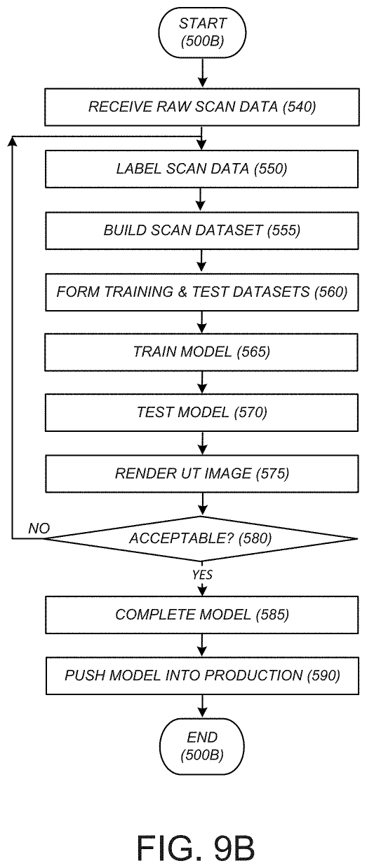

The MTT unit 180 can be arranged to interact with the machine learning platform to train the ML model using a training dataset, in which case the training dataset can be received from an external source (not shown) or created by the ADS system 100, as described below, with respect to the training process 200 (shown in FIG. 6) or process 500 (shown in FIGS. 9A and 9B). The MTT unit 180 can be further arranged to test the ML model using testing datasets. Once the ML model is trained, the MTT unit 180 can be arranged to provide a feedback mechanism, such as, for example, inputting label tuning commands to the ML platform to optimize the ML model by tuning parametric values in the ML model, as described above with respect to FIG. 4.

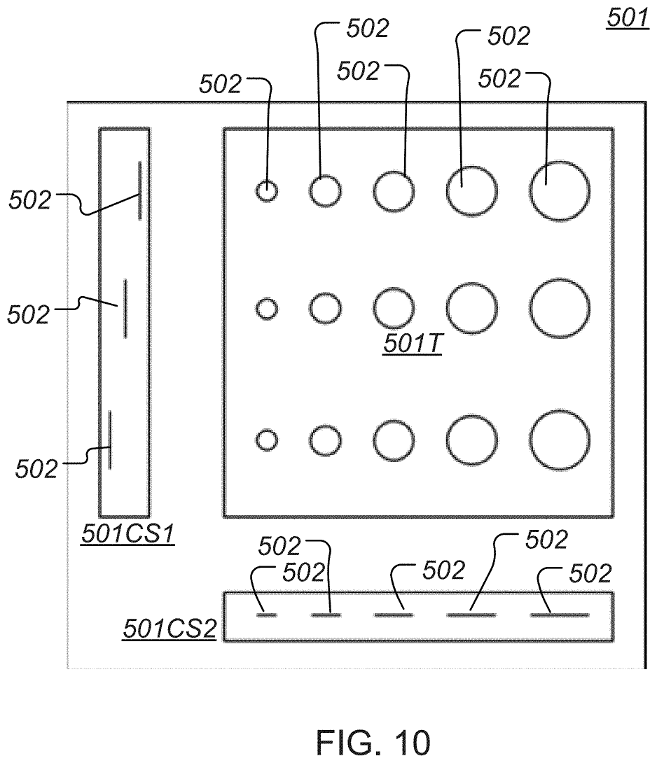

FIG. 6 shows a non-limiting embodiment of a training process 200 that can be performed by, for example, the MTT unit 180 (shown in FIGS. 5 and 8) for a plurality of UT image frames to create the training dataset that can be used by the ML platform to train or optimize the ML model. Although shown for a single UT image frame, it is noted the training process 200 can be performed repeatedly for each UT image frame in the plurality of UT image frames until all UT image frames for the training dataset have been analyzed and labeled. The plurality of UT images (for example, UT image frames 30, shown in FIG. 3) can be received in real-time, such as, for example, from the UT transducer 20 (shown in FIG. 1) or retrieved from the storage 120. The UT images can include, for example, tens, hundreds, thousands, hundreds of thousands, or more UT image frames of the asset 10 (shown in FIG. 1). As noted previously, each UT image frame can include an ultrasound scan file for a section of the asset. The UT images can include UT scans that were previously analyzed and labelled, or UT scans of assets that are operating under real-world conditions, such as, for example, in the field, plant, or other facility. The UT images can include ultrasound scans that are the result of, for example, carefully conducted laboratory experiments in order to induce a desired aberration on a section of the asset, such as, for example, described below with respect to FIGS. 9A and 10. In this regard, the aberration can be created or developed to mimic a real-world aberration that can form or develop in the asset, and predict development of aberration over its life cycle, from formation through failure, damage or some other set point in the life cycle of the aberration, by, for example, controlling the conditions or surrounding of the asset under observation, including use of catalysts.

Referring to FIGS. 5 and 6, a UT image frame is received by the ADS system 100 from an external source, such as, for example, the UT transducer 20 (shown in FIG. 1) (Step 202). The UT image frame can be received by the processor 110 or ADE stack 160 directly from the external source or from the storage 120. The UT image frame pixels can be divided into a plurality image blocks (Step 205). Each image block corresponds to a unique region of the image frame, without any overlapping pixels. The image bloc can include, for example, a two-dimensional b×d array of pixels, where b is a number of pixels located consecutively along a row of image pixels and d is a number of pixels located consecutively along a column of image pixels, where b and d are positive integers greater than 1, and where b and d can have the same or different values. Alternatively, the image pixels in the image frame can be divided such that the image blocks have different dimensions from each other. The image block can be scaled such that it cannot comprise more than one aberration per image block. Depending on the type of aberration, the aberration can extend across multiple image blocks or entirely contained in a single image block. Each image block can include a unique address with respect to the image frame.

All the image blocks can be rendered, for example, by the image rendering unit 170, on a display device to display the original UT image from which they were derived (Step 210). The image rendering unit 170 can include a computing device or, as previously noted, a computer resource that can be executed by the processor 110. The UT image frame can be rendered locally on the display device (not shown) via the IO interface 140 or driver unit 150, or communicated to the computer 50, where the image frame can be rendered on the display device of the computer 50 (shown in FIGS. 3 and 4). The UT image frame can be rendered in the GUI (for example, shown in FIG. 4). Selector commands can be received from a user for each aberration or image block (Step 215) and a determination made, for example, by the MTT unit 180, whether selector commands have been received for all image blocks (Step 220). A selector command can include a notation by the user that annotates an image block as a contration or a nonration category image block. The annotation can include for a given aberration the type of aberration, dimensions of the aberration and location(s) of the aberration. If it is determined that selector commands have been received for all image blocks in the UT image frame (YES at Step 220), then the image blocks can be separated into two image block categories (Step 225), otherwise a message can be generated and displayed to the user, prompting the user to review any unannotated image blocks that might remain in the UT image frame (NO at Step 220, then Step 215).

In Step 225, the annotated image blocks can be separated into two category groups—that is, conration category and nonration category image blocks. The conration category comprises all image blocks that were selected by the user as containing a confirmed aberration (“conration”). The nonration category comprises all image blocks that were confirmed and selected by the user as not containing any aberration (“nonration”)—in other words, image blocks that are confirmed to correspond to only healthy parts of the asset under observation. For all image blocks that are determined to be nonration category (or healthy) image blocks (YES at Step 230), metadata can be generated for each such image block identifying it as a nonration category image block (Step 235) and the image block can be labeled by associating the metadata with the image block or embedding the metadata in the image block (Step 240). The labeled nonration category image blocks can be stored (Step 270), for example, in the storage 120 (shown in FIG. 5).

On the other hand, all image blocks that are determined to be conration category image blocks (NO at Step 230) can be identified as containing confirmed aberrations and the user can be prompted to provide aberration-specific data for each such image block (Step 245). The conration category image blocks can be identified by, for example, highlighting each aberration on the display device, for example, as seen for aberrations 52, 54, 56 (shown in FIG. 4). The highlighting can be rendered on the local display device via the video driver 150B in response to commands from the processor 110, or on the computer 50 (shown in FIG. 3 or 4) based on the image rendering signal from the ADS system 100, for example, from the image rendering unit 170 (shown in FIG. 5).

As seen in FIG. 4, the UT image can be rendered in the display region 50A together with selectable annotations in the annotation display regions 50B and 50C. The display region 50B can include a menu or list of possible aberration types that can occur on the asset under observation (for example, asset 10, shown in FIG. 1 or 2), or it can include a data field (not shown) that can be selected by the user to enter data for an aberration type. The display region 50C can include a menu or list of possible asset types—such as, for example, metal pipe, composite material pipe, composite slab, composite material pipe with metal connectors, or any other asset type or material. The display region 50C can include a data field (not shown) for manual entry of data for an asset type. The GUI can allow the user to select a particular aberration (for example, aberration 52) and then select or enter an annotation for that particular aberration (52) in display region 50B that describes or identifies the aberration type, such as, for example, no aberration (“NO DEFECT”), hydrogen-induced-cracking (“HIC”), step-wise-cracking (“SWC”), “BLISTER”, inner-wall corrosion (“IW CORR”), surface crack (“SURF CRACK”), or local thinned area (“LTA”). The GUI can allow the user to select or enter a descriptor or identification for the type of asset under observation (for example, asset 10, shown in FIG. 1 or 2) from a list in display region 50C.

The GUI can be arranged to receive additional aberration-specific parameters for each aberration, including, for example, dimensions (for example, height, width, length, depth, radius, diameter) and location (for example, x, y, or z Cartesian coordinates). The GUI can be arranged to allow the user to operate a cursor (for example, using a mouse or stylus) to mark a plurality of points on the display screen (for example, shown in FIG. 4), which can then be used by the GUI, for example, through interaction with the processor 110 (shown in FIG. 5) or the computer 50 (shown in FIG. 4), to calculate and determine shape, dimensions and locations of each aberration.

The annotations made by the user for each aberration can be communicated from the GUI to the MTT unit 180 (shown in FIG. 5), which can generate metadata for each aberration or conration category image block (Step 255). The annotations can be communicated to the MTT unit 180 as label tuning commands. The metadata can be stored in the storage 120 and associated with corresponding image blocks, which can also be stored in the storage 120, or the metadata can be embedded in the image block data and stored as labeled image block data in the storage 120. The MTT unit 180 can include a computing device or, as previously noted, a computer resource that can be executed by the processor 110. The MTT unit 180 can generate metadata for each aberration or contration category image block that includes, for example, aberration type, aberration dimensions, and aberration location(s) with respect to the asset under observation.

The generated metadata can include indexing data for each aberration, which can identify each conration category image block that contains a portion of the aberration. The generated metadata can include section indexing data for each asset under observation, including, for example, the aberration area ratio and the number of aberrations, as a function of time, for a section (for example, section 15, shown in FIG. 2) of the asset under observation.

The aberration area ratio can be determined by the MTT unit 180 by summing the total area of each aberration in a section of the asset, determining the total area of that section, and dividing the resultant sum of aberration areas by the total area of the section. The number of aberrations can be determined by the MTT unit 180 by adding the number of aberrations that appear in that same section of the asset. For instance, the Defect-Area-Ratio and Number of Defects can be measured during the classification stage at the classification unit 164 (shown in FIG. 5 or 8), followed by model training at the MTT unit 180.

Each conration category image block can be labeled or stored with its corresponding metadata (Step 260). A determination can be made whether all conration category image blocks have been labeled in the UT image frame (Step 265). If it is determined that all conration category image blocks have been labeled (YES at Step 265), then all the labeled conration category image blocks can be stored with the nonration category image blocks for the UT image frame (Step 270), otherwise (NO at Step 265) the user can be prompted to enter annotations for any unlabeled conration category image blocks remaining, which can be used as, or to update, parametric values in the ML model (Step 245). The labeled UT image frame, including all conration and nonration category image blocks with metadata, can be stored in the storage 120 (shown in FIG. 5) or an external storage (not shown), such as, for example, in a user-defined folder in the external storage device.

A determination can be made, for example, by the MTT unit 180 (shown in FIG. 5), whether an additional UT image frame should be included in the training dataset (Step 275). If it is determined that an additional UT image should be included (NO at Step 275), such as, for example, where the training dataset is incomplete, then an additional UT image frame can be received (Step 202) and Steps 205 to 275 repeated, otherwise (YES at Step 275) a determination can be made whether to train the ML model in the ADS system 100 (Step 280) or hold the training dataset in storage 120 for use at a later time (NO at Step 280). If it is determined that the ML model should be trained (YES at Step 280), then the ML model can be trained using the stored training dataset, thereby updating the ML model parameters, and launched upon completion of training (Step 285).

The training dataset, which includes an accumulation of labeled UT scan images, can be used to create a training database in DB 120D (shown in FIG. 5) or to augment an existing ultrasound scan database to re-train the ML model in the ADS system 100 for improved performance. Based on the performance of the re-trained ML model, a determination can be made to deploy the retrained model on the ADS system 100 in lieu of the currently deployed ML model.

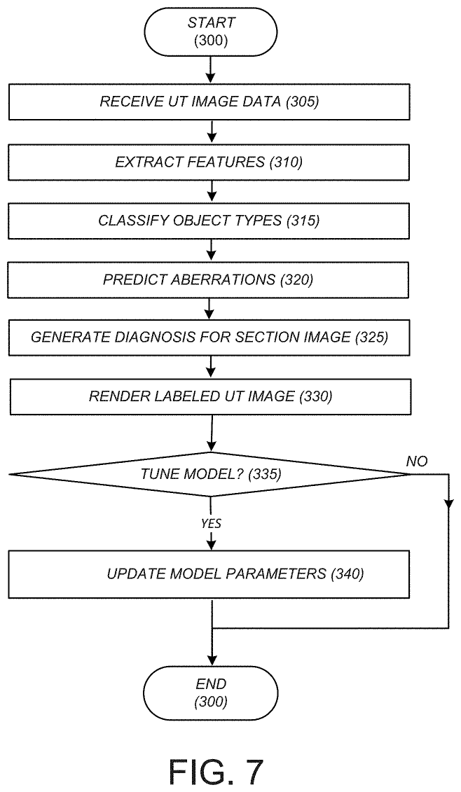

FIG. 7 shows a non-limiting embodiment of an aberration evaluation process 300, according to the principles of the disclosure. The process 300 can begin with the ADE stack 160 (shown in FIG. 5) receiving UT image data for a section of an asset under observation (Step 305). The image data can be retrieved from the storage 120 (shown in FIG. 5) or received from an external source, such as, for example, the NDE transducer 20 (shown in FIG. 1). The received UT image data can be parsed by, for example, the processor 110. The processor 110 can separate any metadata that might be present in the UT image data, including, for example, location data or time stamp data that indicates the place or time the image in the image data was captured by, for example, the NDE transducer 20 (Step 305). The parsed metadata can include an identification of the ultrasound transducer device used to capture the images. The location data can include, for example, x-y-z Cartesian coordinates, Global Positioning Satellite (GPS) coordinates, or any other location identification system that can accurately identify the actual physical location of the section of the asset under observation. The image data can be formatted and features extracted by, for example, the feature extraction unit 162 (shown in FIG. 5) (Step 310). Each object in the image data can be classified, for example, by the classification unit 162, with an object type (Step 315).

The ML model in the ADS system 100 can include the latest modelling parameters, which can be used, for example, by the aberration predictor 166, to predict aberrations and aberration types in the section of asset under observation (Step 320), based on the extracted features and object classifications. The aberration predictor 166 can use historical UT image data for the section of asset under observation (for example, section 15, shown in FIG. 2) or other assets of substantially the same or similar type. The historical UT image data can include, for example, stored images of an aberration previously detected or predicted and labeled, or a section of the asset that was monitored or observed over a period of time (e.g., minutes, hours, days, weeks, months, or years). The historical UT image data can include a training dataset, such as, for example, the training dataset created by the process 200 (shown in FIG. 6) or process 500 (shown in FIGS. 9A and 9B) and contained in the storage 120 (shown in FIG. 5). Each aberration can be annotated, for example, by the labeler unit 168, with an aberration label comprising the aberration type, the dimensions of the aberration, the location(s) of the aberration, and the aberration area. Additionally, each UT image frame can be annotated, for example, by the labeler unit 168, with a section condition label comprising the overall area of the section, an overall aberration area ratio for the section, and the total number of aberrations in that section of the asset.

On the basis of the section condition label information, including each aberration label, a degree of health condition of the section can be determined, for example, by the labeler unit 168 (shown in FIG. 5), and a diagnosis generated for the degree of health condition of the section (Step 325).

The labeled UT image data, including the raw UT image data and all annotations provided for that UT image, can be communicated, for example, by the image rendering unit 170, and the UT image rendered and displayed with a corresponding section condition label and an aberration label for each aberration (Step 330). The labeled UT image can be rendered, for example, on a computer resource asset operated by a field crew and displayed on a display device, so that members of the field crew can utilize information learned from the labeled UT image to identify or schedule tasks relating to the assets under observation, including, for example: repair or replace a section of the asset that has been damaged or is likely to become damaged or fail; or to place the section of the asset on a watch list, so as to monitor one or more aberrations over their respective life cycles.

Alternatively, in place of a field crew, the solution can be automated and the remediation or monitoring tasks can, instead, be performed by an automated tool (not shown), such as, for example, a robot, in which case the tool can be arranged to receive the labeled UT image data and schedule or execute remediation or monitoring tasks for the section of asset under observation based on the labeled UT image data, including the diagnosed degree of health condition of the section and section condition label.

After the UT image data is rendered by the GUI on the display device (for example, shown in FIG. 3 or 4), a determination can be made, for example, by the MTT unit 180 (shown in FIG. 5), whether any feedback (for example, a label tuning command) is received from the GUI relating to any of the labels for the section or aberrations displayed by the GUI (Step 335). If feedback is received (YES at Step 335), such as, for example, a feedback signal from the computer 50 that includes label tuning commands and data, which can be input to the ML platform to tune the ML model by, for example, modifying, deleting or adding an aberration label for the displayed aberration 52 (shown in FIG. 4), then the MTT unit 180 can operate to update the ML model parameters based on the feedback signal (Step 340), otherwise (NO at Step 335) the process 300 can end.

By carrying out the process 300, the ADS system 100 (or DADS system, shown in FIG. 8) can analyze ultrasound scans to generate a list of defects in a scan and label defective areas in the analyzed ultrasound scan that might need investigation, repair, replacement, or continued monitoring. The ADS system 100 can process the received scans to generate label metadata for each section of the asset under observation, including, a defect area ratio, the number of defects and individual defect sizes as a function of time. The ADS system 300 can predict and render predicted aberrations in the ultrasound scans based on calculated parameters in the ML model and how they evolve over time, and cause the display device to render the detected or predicted aberrations, which can include a rendering of the life cycle of each aberration.

As noted previously, the ADS system 100 can analyze individual UT images or a plurality of UT scan images from the same section of the asset taken at different times. In the latter instance, the ADS system 100 can track individual aberrations across different UT scans (taken at different times), thereby tracking changes in location, dimensions or shape of the aberration over longer periods of time, such as, for example, months, years, or decades. The ultrasound scans can include 0-degree AUT C-scans. The ADS system 100 can facilitate or perform, for example, (1) assessment of the fitness for service of an asset under observation in near real time using, for example, API 579, (2) determining an inspection frequency for a section of the asset or the entire asset, or (3) identifying or scheduling any needed maintenance activity to address the specific aberration being observed.

The ADS system 100 can operate with a variety of types of UT scan images, including conventional or advanced UT images. The ADE stack 160 can detect each aberration, classify the aberration and quantify the dimensions of the aberration for different types of aberrations. The ADE stack 160 can analyze tens, hundreds, thousands or more UT images efficiently and effectively to timely identify and evaluate aberrations, including the most dangerous or largest defects that might exist or develop in assets, and generate a diagnosis for the degree of health condition of a section or the entire asset.

While the ADS system 100 and processes 200 or 300 can be agnostic of the material under observation and can operate with a variety of ultrasound scan image types, the system and processes can operate especially well with clear C-Scan UT images, including 0-degree advanced UT (AUT) C-scans. However, where the material under observation is a material like the composite materials frequently employed in oil or gas industry pipelines as of the date of this disclosure, the received UT images can be less than optimal and, therefore, challenging to analyze for aberrations. In those instances, clear AUT C-Scan images can be obtained directly or indirectly through, for example, creation by post-processing of “noisy” or incoherent data as will be understood by those skilled with UT image data processing.

FIG. 8 shows a non-limiting embodiment of a denoised aberration detection and assessment (DADS) system 400, constructed according to the principles of the disclosure. In addition to the computer resource assets included in the ADS system 100 (shown in FIG. 5), the DADS system 400 includes a denoising unit 190, which can preprocess received UT images. The denoising unit 190 can be activated via a user interface, such as, for example, the GUI (shown in FIG. 4) to preprocess a noisy UT image (for example, UT image 503N, shown in FIG. 11) to output a denoised or clear UT image (for example, UT image 503C, shown in FIG. 1), which can then be analyzed to detect or predict aberrations in a section of an asset being investigated to determine a diagnosis of degree of health of the section.

For instance, when an ultrasound scan image is analyzed and assessed according to the process 300 (shown in FIG. 7), a noisy UT image (UT image 503N, shown in FIG. 11) might be rendered on the display device (shown in FIG. 3 or 4), depending on the material contained in the section of the asset, or the type or quality of the original ultrasound scan image. In this regard, a user can select a “DENOISE” option (not shown) on the GUI, which can then trigger the denoising unit 190 to preprocess the UT image and provide a denoised or clear UT image (UT image 503C, shown in FIG. 11). The denoised UT image data can be input to the machine learning model for aberration detection, analysis and labeling, according to the process 300 (shown in FIG. 7), or the process 200 (shown in FIG. 6), or the process 500B (shown in FIG. 9B).

The DADS system 400 can work with ultrasound C-scans, 0-degree advanced ultrasound (AUT) C-scans, angled advanced ultrasound (AUT) C-scans (that is, having angle greater or less than 0-degrees), conventional ultrasound scan images or other types of ultrasound scan images. The DADS system 400 can analyze UT images that are not entirely clear or that are of lower quality or resolution than, for example, 0-degree AUT C-scan images. As seen in FIG. 8, the DADS system 400 can be constructed similar to the ADS system 100 (shown in FIG. 5), with addition of the denoising unit 190. The DADS system 400 can filter out noise from noise UT scan images to render a clear UT scan image (for example, 503C, shown in FIG. 11), wherein the aberrations (for example, 12 and 14, shown in FIG. 11) can readily be identified and discerned, whether automatically by the DADS system 400 or interaction with an operator via the IO interface 140.

The denoising unit 190, which can include a computing device or a computer resource that is executable on the processor 110 as one or more computer resource processes, can preprocess and denoise each UT scan image of asset comprising a composite material to output a denoised and clear UT image (for example, UT image 503C, shown in FIG. 11), which can then be analyzed by the machine learning platform to detect or predict aberrations and assess a degree of health for the section.

After the UT scan images are denoised by the denoising unit 190, the image data can be analyzed to detect or predict aberrations and evaluate the aberrations in the same manner as discussed above with respect to FIGS. 1-7. The denoising unit 190 can be arranged to allow for investigation of nonmetallic assets by the DADS system 400 even where the underlying assets have large amounts of internal defects or voids that can be commonplace for assets containing composite materials, for example, as seen in the depiction of the noisy UT image 503N in FIG. 11.

The denoising unit 190 can include an ML platform, such as, for example, an ANN, a CNN, a DCNN, an RCNN, a Mask-RCNN, a DCED, an RNN, an NTM, a DNC, an SVM, a DLNN, or any combination of the foregoing. The denoising unit 190 can be included in the machine learning platform of the ADS system 100 (shown in FIG. 5). The denoising unit 190 can include an ML model trained to detect, identify and remove noise from noise UT images.

In an alternative embodiment, the denoising unit 190 can be combined with or integrated in the ADE stack 160. For example, in the non-limiting embodiment where the ADE stack 160 comprises computing resources that are executable by the processor 110 to perform the processes 200, 300 or 500 (shown in FIGS. 6, 7, 9A and 9B), the ADE stack 160 can include the denoising unit 190. In that case, the denoising unit 190 can be included in the ADE stack 160 as a computing resource that is executable by the processor 110 to preprocess and remove noise from a noisy UT image scan (for example, UT image 503N, shown in FIG. 11) to output a denoised or clear UT image scan (for example, UT image 503C, shown in FIG. 11) to the feature extraction unit 162, classification unit 164, aberration predictor 166 or labeler unit 168 (shown in FIG. 8).

An important reason that nonmetallic initiatives in industries such as oil and gas have been slow to replace metallic assets with nonmetallic alternatives is the lack of a fast, safe and cost-effective testing solution that can provide timely assessments of the quality and condition of composite assets—that is, assets comprising composite materials. While inspection technologies such as radiography or thermography can be effective, they have not been practical due their significant costs. Other technologies, such as electro-capacitive tomography, are under development but are not sufficiently mature to be viable alternatives. Ultrasound testing (UT) technologies, on the other hand, are fast, safe and cost-effective, but they have been ineffective and unusable in industries such as oil and gas. An important reason that UT technologies have been ineffective or unusable in such industries is the industries' use of lower quality polymers in making the composite assets, which typically contain large numbers of internal defects or voids that cause significant signal attenuation, thereby rendering most UT images of composite assets noisy, incoherent and, resultantly, unusable. The solution provided by this disclosure, including the DADS system 400, allows for use of conventional ultrasound inspection technologies to investigate and evaluate composite assets, including those made of lower quality polymers that typically include large amounts of aberrations such as defects or voids.

The solution, including the DADS system 400, can operate with conventional UT images of assets containing composite materials, such as, for example, composite slabs, pipes or pipelines, tees, joints, bends, valves, nozzles, or vessels, to name a few, thereby enabling their inspection and evaluation. The solution can process UT images received from tried and tested non-destructive testing technologies of (low quality) composite assets to produce clear ultrasound C-scan images from “noisy” UT images. The denoising unit 190 can be arranged to analyze a UT image frame, identify or detect benign aberrations and filter such aberrations from the UT image frame to output a clear UT image frame of comparable or higher quality than traditional 0-degree AUT C-scan images of metallic assets.

FIGS. 9A and 9B show a non-limiting embodiment for a machine learning (ML) model training process 500, which can include processes 500A and 500B, according to the principles of the disclosure. The process 500A is directed to building a baseline dataset with artificially induced aberrations in a section of an asset that is substantially the same as or similar to the asset that will be investigated by the DADS system 400 (or ADS system 100, shown in FIG. 5). The process 500B is directed to building a training dataset and training the ML model in the machine learning platform to detect or predict and analyze and assess aberrations in a section under investigation to generate a diagnosis of a degree of health of the section. In the DADS system 400 (shown in FIG. 8), the denoising unit 190 can be arranged to filter and remove noise from input noisy UT images and output clear UT images to the ADE stack 160 for analysis and assessment.

FIG. 10 shows three views of a non-limiting example of the section 501 of the asset to be investigated, including a top view 501T, a first side cross-section view 501CS1, and a second cross-section view 502CS2. The section 501 can contain the same or substantially the same material as the asset to be investigated by the ADE stack 160 (shown in FIG. 5 or 8). The section 501 can include, for example, a flat plate of the target material, as seen in FIG. 10. The target material, thickness and damage mechanism can be selected for the section 501 based on the asset and asset type to be investigated, which can dictate the type of material, its thickness and the damage mechanism. The thickness of the section 501 can be substantially the same as or greater than the thickness of the actual asset to be investigated. The damage mechanism can include an aberration type that might form or develop over time in the asset to be investigated. For instance, the aberration type for the damage mechanism can include delamination, a blister, a crack, a hole, or any aberration type that can form or develop in the asset to be investigated. The target material for the section 501 can include a carbon-fibre material, a reinforced thermoplastic pipe (RTP) material, a flexible composite pipe (FCP) material, a reinforced thermosetting resin (RTR) material, a glass fibre material, a glass fibre reinforced plastic (GRP), a glass fibre reinforced epoxy (GRE), or other material that might be included in the asset to be investigated.

Referring to FIG. 9A, after the target material, thickness and damage mechanism are selected, the test section 501 can be created (Step 505). A baseline for the asset to be investigated can be created by creating or inducing one or more artificial aberrations in the test section 501 (Step 510). An aberration can be created or induced in the test section 501 via, for example, an experimental methodology or by machining an expected aberration geometry in the section 501. For instance, as seen in the non-limiting example in FIG. 10, a plurality of flat bottom holes 502 of varying diameters (views 501T and 501CS2) and varying depts. (view 501CS1) can be machined onto the section 501. All the holes 502 should be machined with tight tolerances.

In an alternative embodiment, an experimental methodology, such as, for example, that used for tensile testing, fatigue testing, accelerated aging, among others, can be used to create or induce the artificial aberration that can form or develop in the asset to be investigated.

Alternatively, an expected geometry of an artificial aberration can be determined based on, for example, a geometry described in the literature or simulated using finite element modelling, as will be understood by those skilled in the art.

FIG. 11 shows non-limiting examples of a pair of expected geometries for artificial aberrations 12 and 14 that can be generated on the test section 501 to train the ML model for use with the asset 10 (shown in FIG. 2). Once the ML model is trained by the process 500, the model can detect, analyze and label the aberrations 12 and 14 in the noisy UT image 503N, for example, via the ADE stack 160 (shown in FIG. 8). The ML model can also detect and identify the noise in the noisy UT image 503N. The denoising unit 190 (shown in FIG. 8) can, by the ML model, identify and filter out the noise in the noisy UT image 503N and output a clear UT image 503C to the ADE stack 160 (shown in FIG. 8).

Once alteration of the test section 501 is complete (Step 510), such as, for example, where machining of the holes is completed, the dimensions of each artificial aberration can be measured (Step 515), which in the case of the section 501 includes measuring the location, diameter and depth of each hole 502 using, for example, a profilometer. The measurement values (including location, height, width, length, depth, diameter, radius, angle) for each artificial aberration can be stored (Step 520), such as, for example, in the storage 120 (shown in FIG. 5 or 8). The altered test section 501 can be scanned (Step 525) using an ultrasound transducer device (not shown), such as, for example, the same ultrasound transducer device or the same type of ultrasound transducer device included in the NDE transducer 20 (shown in FIG. 1). In Step 525, various ultrasound transducer devices (not shown) and frequencies can be tested to identify an optimal combination. The resultant ultrasound testing image data can be saved (Step 530), for example, I the storage 120 (shown in FIG. 5 or 8).

A determination can be made whether the baseline dataset is complete (Step 530). If it is determined that the baseline dataset is incomplete (NO at Step 530), such as, for example, where UT scan data is needed for additional artificial aberrations, then another test section 501 can be created (Step 505) and the process 500A repeated, otherwise (YES at Step 530) all saved UT scan data for the completed baseline data set can be exported (Step 535), such as for example, for long term storage in DB 120D or for use by the process 500B (shown in FIG. 9B).

Referring to FIG. 9B, a complete baseline dataset, including all raw UT scan data, can be received by the process 500B (Step 540). The baseline dataset can be received from the process 500A directly or retrieved from, for example, the storage 120 (shown in FIG. 5 or 8). For each scanned image the UT scan image data can be annotated based on the actual locations and dimensions of each aberration in the image and a label generated for each aberration according to the annotation (Step 550). A UT scan dataset can be built (Step 555), for example, by indexing each label to its corresponding aberration in the UT image. For a given UT scan image, the UT image can be provided as a unique UT scan file and all the annotations for the UT image can be provided in a label file, wherein each label is indexed to a respective aberration in the UT image. In a non-limiting embodiment, the annotations will be accompanying the UT image such that the dataset becomes comprised of pairs of images and their annotations.

Once the dataset is curated (in Step 555), it can be split into a training dataset and a testing dataset (Step 560). The training dataset can then be used to train the ML model in, for example, the ADS system 100 (shown in FIG. 5) or DADS system 400 (shown in FIG. 8) (Step 565). The ML model can be trained to accomplish at least two tasks. First, the ML model can be trained to segment or divide the UT image into conration category image blocks and nonration category image blocks, where pixels of the UT image are assigned labels of either aberration or non-aberration, respectively. Next, if a pixel is assigned an aberration label (a contration category pixel), then that pixel can be assigned a number that denotes a depth or severity of the aberration. The ML model can be trained until a desired performance is achieved

The testing dataset can be applied to the ML model to test the model's performance (Step 570). The testing dataset can be applied and the ML model caused to render a UT image based on the testing dataset (Step 575). Based on the performance of the ML model, a determination can be made whether training of the ML model is complete (Step 580), for example, by comparing the rendered UT image, including labels for each aberration in the UT image, to the original UT image and labels. If the rendered UT image, including machine generated labels, mimics the original UT image and labels within an acceptable range (YES at Step 580), then it can be determined the model has been successfully trained (Step 585), otherwise (NO at Step 580) the process 500B can return and repeat from Step 550, including tuning of the parametric values of the ML model.

Once the model is complete (Step 585), the model can be pushed into production (Step 590), such as, for example, in the ADE stack 160 (shown in FIG. 5 or 8). The trained ML model can then operate according to the process 300 (shown in FIG. 7) (or process 200, shown in FIG. 6) to analyze the noisy UT image 503N (shown in FIG. 11) of the section 15 (shown in FIG. 2) received from the NDE transducer 20 (shown in FIG. 1) and filter out the noise, for example, by the denoising unit 190 (shown in FIG. 8), to input the denoised or clear UT image 503C (shown in FIG. 11) to the ADE stack 160 (shown in FIG. 8) to detect, assess and label the aberrations 14 and 15 in the section 15 under inspection (shown in FIG. 3).

The terms “a,” “an,” and “the,” as used in this disclosure, means “one or more,” unless expressly specified otherwise.

The term “aberration,” as used in this disclosure, means an abnormality, an anomaly, a deformity, a malformation, a defect, a fault, a delamination, an airgap, a dent, a scratch, a cracks, a hole, a discolorations, or an otherwise damaged portion or area of an asset that could have a negative or undesirable effect on the performance, durability, or longevity of the asset 10.

The term “backbone,” as used in this disclosure, means a transmission medium that interconnects one or more computing devices or communicating devices to provide a path that conveys data signals and instruction signals between the one or more computing devices or communicating devices. The backbone can include a bus or a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The term “communicating device,” as used in this disclosure, means any hardware, firmware, or software that can transmit or receive data packets, instruction signals, data signals or radio frequency signals over a communication link. The communicating device can include a computer or a server. The communicating device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit (CPU), a graphic processing unit (GPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The terms “computing resource” or “computer resource,” as used in this disclosure, means software, a software application, a web application, a web page, a computer application, a computer program, computer code, machine executable instructions, firmware, or a process that can be arranged to execute on a computing device or a communicating device.

The term “computing resource process,” as used in this disclosure, means a computing resource that is in execution or in a state of being executed on an operating system of a computing device. Every computing resource that is created, opened or executed on or by the operating system can create a corresponding “computing resource process.” A “computing resource process” can include one or more threads, as will be understood by those skilled in the art.

The terms “computer resource asset” or “computing resource asset,” as used in this disclosure, means a computing resource, a computing device or a communicating device, or any combination thereof.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and their variations, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The term “transmission” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

The terms “UT scan image” or “UT image,” as used in this disclosure, means an ultrasound image of an asset or a section of an asset under observation, such as, for example, an ultrasound scan or ultrasound image captured or recorded by a pulse-echo transducer device, pitch-catch transducer device, phased array transducer device, composite transducer array device, or any other type of transducer device or technology capable of capturing or recording ultrasound images or scans of the asset or section of asset under observation.

The term “UT image frame,” as used in this disclosure, means ultrasound image data for an area or section under observation of an asset under inspection, comprising image data that can be rendered as a one-dimensional image (for example, single line with varying brightness), two-dimensional image (as seen in FIG. 3 or 4), or a three-dimensional image (not show) on a display device. A UT image frame can include a single UT scan file. Two or more UT scan files of adjacent or conjoined sections of an asset under inspection can be stitched together by compositing the UT scan files to render a single UT image frame. A UT image frame can include only a portion of the image data contained in a single UT scan file.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A computer-implemented method for analyzing a sequence of ultrasound scan images of an asset and diagnosing a health condition of a section of the asset, the method comprising:
receiving, by a machine learning platform, an ultrasound scan image of the section of the asset;
analyzing, by the machine learning platform, the ultrasound scan image to detect any aberrations in the section;
generating, by the machine learning platform, an aberration label for each detected aberration in the section;
labeling, by the machine learning platform, the section of the asset with a section condition label; and,
rendering, by a display device, the section conditional label,
wherein the section condition label is based on each detected aberration in the section, and
wherein the section condition label includes at least one of an aberration area ratio, a total number of aberrations, and the aberration label for each detected aberration in the section of the asset.

2. The method in claim 1, further comprising:
generating a diagnosis of degree of health condition of the section of the asset based on the section condition label.

3. The method in claim 1, further comprising:
receiving, by the machine learning platform, an aberration label tuning command.

4. The method in claim 3, further comprising:
updating, by the machine learning platform, a parametric value of a machine learning model based on the aberration tuning command.

5. The method in claim 4, further comprising:
analyzing, by the machine learning model, another ultrasound scan image of the section of the asset imaged,
wherein the ultrasound scan image and said another ultrasound scan image are imaged at different times.

6. The method in claim 5, further comprising:
generating, by the machine learning model, another aberration label for each detected aberration in the section;
labeling, by the machine learning model, the section of the asset with another section condition label; and,
rendering, by a display device, said another section conditional label,
wherein said another section condition label is based on each said another aberration label for each detected aberration in the section, and
wherein said section condition label includes at least one of another aberration area ratio, another total number of aberrations, and said another aberration label for each detected aberration in the section of the asset.

7. The method in claim 1, wherein the aberration in the section includes at least one of:
a hydrogen induced crack defect;
a step-wise crack defect;
a hydrogen blister;
an inner wall corrosion;
a surface crack; and
a local thinned area.

8. The method in claim 1, wherein the machine learning platform is asset agnostic.

9. The method in claim 1, wherein the asset comprises a metallic material.

10. The method in claim 1, wherein the asset comprises a composite material.

11. An inspection and assessment system for analyzing a sequence of ultrasound scan images of an asset and diagnosing a health condition of a section of the asset, the system comprising:
an input-output interface arranged to receive an ultrasound scan image of the section of the asset;
a feature extraction unit arranged to extract features of an aberration from the ultrasound scan image;
a classification unit arranged to classify the aberration based on the extracted features;
an aberration predictor unit arranged to analyze the extracted features and classification of the aberration, detect each aberration in the section and determine an aberration type, an aberration dimension or an aberration location for each aberration in the section;
a labeler unit arranged to generate a diagnosis of a degree of health of the section and label the section with a section condition label; and
an image rendering unit arranged to send an image rendering signal to cause a display device to render the section condition label on the display device with the ultrasound scan image.

12. The system in claim 11, wherein the section condition label is based on each detected aberration in the section.

13. The system in claim 11, wherein the section condition label includes at least one of an aberration area ratio, a total number of aberrations, and the aberration label for each detected aberration in the section of the asset.

14. The system in claim 11, further comprising:
a model training and tuning unit arranged to update a parametric value of a machine learning model in the system based on an aberration tuning command.

15. The system in claim 11, comprising:
a machine learning platform that includes the feature extraction, classification unit, aberration predictor unit, or labeler unit.

16. The system in claim 15, wherein the machine learning platform is arranged to:
generate, by the machine learning model, another aberration label for each detected aberration in the section;
label, by the machine learning model, the section of the asset with another section condition label; and,
render, by the display device, said another section conditional label,
wherein said another section condition label is based on each said another aberration label for each detected aberration in the section, and
wherein said section condition label includes at least one of another aberration area ratio, another total number of aberrations, and said another aberration label for each detected aberration in the section of the asset.

17. The system in claim 11, wherein the aberration in the section includes at least one of:
a hydrogen induced crack defect;
a step-wise crack defect;
a hydrogen blister;
an inner wall corrosion;
a surface crack; and
a local thinned area.

18. The system in claim 15, wherein the machine learning platform is asset agnostic and the asset comprises either a metallic material or a composite material.

19. A non-transitory computer readable storage medium containing aberration analysis and assessment program instructions for analysis of a sequence of ultrasound scan images of an asset and diagnosis of a health condition of a section of the asset, the program instructions, when executed by a processor, causing the processor to perform an operation comprising:
receiving, by a machine learning platform, an ultrasound scan image of the section of the asset;
analyzing, by the machine learning platform, the ultrasound scan image to detect any aberrations in the section;
generating, by the machine learning platform, an aberration label for each detected aberration in the section;
labeling, by the machine learning platform, the section of the asset with a section condition label; and,
rendering, by a display device, the section conditional label,
wherein the section condition label is based on each detected aberration in the section, and
wherein the section condition label includes at least one of an aberration area ratio, a total number of aberrations, and the aberration label for each detected aberration in the section of the asset.

20. The non-transitory computer readable storage medium in claim 19, wherein the aberration in the section includes at least one of:
a hydrogen induced crack defect;
a step-wise crack defect;
a hydrogen blister;
an inner wall corrosion;
a surface crack; and
a local thinned area.
